(19) United States
(12) Patent Application Publication
(10) Pub. No.: US 2025/0128170 A1
(43) Pub. Date: Apr. 24, 2025

(54) Systems and Methods for Supporting Team-Based Video Game Play

(71) Applicant: Sony Interactive Entertainment Inc., Tokyo (JP)

(72) Inventors: Victoria Dorn, San Mateo, CA (US); Genie-Rose Luluquisin, San Mateo, CA (US); Sirisha Kesiraju, San Mateo, CA (US); Meena Negi, San Mateo, CA (US); Angela Bartolome, San Mateo, CA (US)

(21) Appl. No.: 18/489,787

(22) Filed: Oct. 18, 2023

(51) Int. Cl. A63F 13/67; A63F 13/5375; A63F 13/795; A63F 13/798; A63F 13/87

(52) U.S. Cl. CPC A63F 13/67; A63F 13/5375; A63F 13/795; A63F 13/798; A63F 13/87

(57) ABSTRACT

Automated detection and handling of team struggle in video game play is provided by a system and method implementing an assessment engine, an assistance engine, and an assistance implementation controller. The assessment engine implements a first artificial intelligence (AI) model to evaluate a performance assessment parameter for a team of players engaged in play of a video game. The assistance engine implements a second AI model to determine an assistive measure for improving play of the team of players within the video game. The assistance engine is engaged when the assessment engine determines that the performance assessment parameter is indicative of the team of players struggling in their play of the video game. The assistance implementation controller implements the assistive measure as determined by the assistance engine within the video game.

### BACKGROUND OF THE INVENTION

The video game industry has seen many changes over the years and has been trying to find ways to enhance the video game play experience for players and increase player engagement with the video games and/or online gaming systems, which ultimately leads to increased revenue for the video game developers and providers and the video game industry in general. It is within this context that implementations of the present disclosure arise.

### SUMMARY OF THE INVENTION

In an example embodiment, a system for automated detection of team struggle in video game play is disclosed. The system includes an assessment engine that is configured to implement a first artificial intelligence (AI) model to evaluate a performance assessment parameter for a team of players engaged in play of a video game. The system also includes an assistance engine that is configured to implement a second AI model to determine an assistive measure for improving play of the team of players within the video game. The assistance engine is engaged when the assessment engine determines that the performance assessment parameter is indicative of the team of players struggling in their play of the video game. The system also includes an assistance implementation controller that is configured to implement the assistive measure as determined by the assistance engine within the video game.

In an example embodiment, a method is disclosed for automatically detecting team struggle in video game play. The method includes evaluating a performance assessment parameter for a team of players engaged in play of a video game. A first AI model is used in evaluating the performance assessment parameter. The method also includes determining an assistive measure for improving play of the team of players within the video game, when the performance assessment parameter is indicative of the team of players struggling in their play of the video game. A second AI model is used in determining the assistive measure. The method also includes implementing the assistive measure within the video game.

### BRIEF DESCRIPTION OF THE DRAWINGS

FIG. 1 shows a cloud gaming network that includes a system for automated detection and handling of team struggle in video game play, in accordance with some embodiments.

FIG. 2 shows an example configuration of the system for automated detection and handling of team struggle in video game play, in accordance with some embodiments.

FIG. 3 shows a set of performance assessment parameters for a team of players within a video game, in accordance with some embodiments.

FIG. 4 shows an example configuration of a system for automated detection and handling of team struggle in video game play, in accordance with some embodiments.

FIG. 5 shows a flowchart of a method for automatically detecting and handling team struggle in video game play, in accordance with some embodiments.

FIG. 6 shows various components of an example server device within a cloud-based computing system that can be used to perform aspects of the system and method for automatically detecting and handling team struggle in video game play, in accordance with some embodiments.

### DETAILED DESCRIPTION OF THE INVENTION

In the following description, numerous specific details are set forth in order to provide a thorough understanding of the present disclosure. It will be apparent, however, to one skilled in the art that embodiments of the present disclosure may be practiced without some or all of these specific details. In other instances, well known process operations have not been described in detail in order not to unnecessarily obscure the present disclosure.

Many modern computer applications, such as video games, virtual reality applications, augmented reality applications, virtual world applications, etc., provide for various forms of team-based user participation. For ease of description, the term “video game” as used herein refers to any of the above-mentioned types of computer applications, or any other type of computer application, that provides for team-based user participation in execution of the computer application. Also, for ease of description, the term “player” (as in video game player) as used herein refers to a user that participates in the execution of a video game.

In various embodiments, a video game controller can be any type of device used to convey user input to a computer system executing the video game. For example, in various embodiments, the video game controller is one or more of a hand-held video game controller, a head-mounted display (HMD) device, a sensor-embedded wearable device (e.g., glove, glasses, vest, shirt, pants, cape, hat, etc.), and/or a wielded control device (e.g., wand, club, gun, bow and arrow, sword, knife, bat, racket, shield, etc.), among others. In team-based video game play, multiple players are assigned to a particular team. Each of the multiple players has one or more video game controllers configured to enable their interaction with the video game and with other players involved with execution of the video game, particularly with other players who are on their team within the context of playing the video game. Also, in various embodiments, each of the multiple players is equipped with a communication capability that enables them to communicate with other players involved with execution of the video game, and especially with other players who are on their team within the context of playing the video game.

In various embodiments, in-game communications are made between different players of the video game. Also, in some embodiments, in-game communications are made between spectators of the video game and players of the video game. Also, in some embodiments, communications are made between virtual entities (e.g., video game-generated entities) and players of the video game. Also, in some embodiments, communications are made between spectators and virtual entities. Also, in some embodiments, communications are made between two or more spectators of the video game. In some embodiments, various players and/or spectators of the video game can be either real people or virtual entities (e.g., AI-generated entities). In some embodiments, a virtual player and/or spectator can be instantiated on behalf of a real person. In various embodiments, communications that are conveyed to, from, or between players within the video game can have one or more of a textual format, an image format, a video format, an audio format, and a haptic format, among essentially any other format that can be implemented within the video game. In various embodiments, the content of a communication made within the video game is one or more of a gesture (made either by a real human body or a virtual entity within the video game), a spoken language statement/phrase (made either audibly or in written form), and a video game controller input.

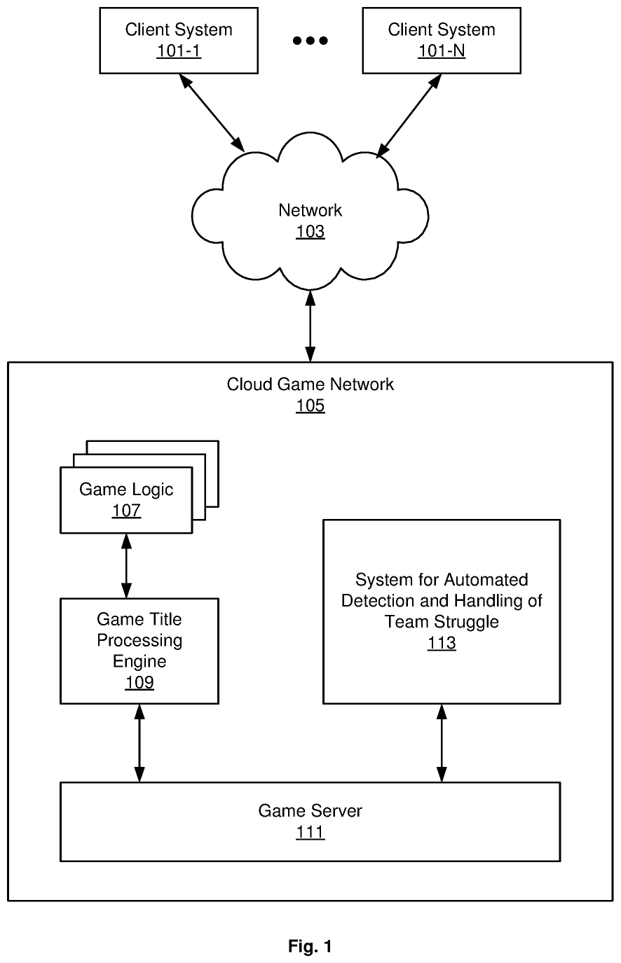

FIG. 1 shows a cloud gaming network 105 that includes a system 113 for automated detection and handling of team struggle in video game play, in accordance with some embodiments. The cloud game network 105 includes a game server 111, a game title processing engine 109 in data communication with the cloud game network 105, and game logic 107 in data communication with the game title processing engine 109. The cloud game network 105 is configured to provide access to video games over a network 103, such as the Internet. In some embodiments, the cloud computing services offered by the cloud game network 105 are accessed by a number of client computing systems 101-1 to 101-N. In various embodiments, the client computing systems 101-1 to 101-N include at least a central processing unit (CPU), a display, and an input/output device. In various embodiments, the client computing systems 101-1 to 101-N are one or more of a game console, a personal computer (PC), a mobile phone, a person digital assistant (PAD), a handheld device, a tablet device, and HMD, or another type of computing device. The client computing systems 101-1 to 101-N are configured to communicate with the game server 111 of the cloud game network 105 by way of the network 103. In some embodiments, the client computing systems 101-1 to 101-N execute network interface applications, such as web browsers, to access and interact with the cloud game network 105 over the network 103.

In some embodiments, data communication through the network 103 within the various embodiments disclosed herein may be facilitated using wireless technologies. Such technologies may include, for example, 5G wireless communication technologies. 5G is the fifth generation of cellular network technology. 5G networks are digital cellular networks, in which the service area covered by providers is divided into small geographical areas called cells. Analog signals representing sounds and images are digitized in the telephone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a pool of frequencies that are reused in other cells. The local antennas are connected with the telephone network and the Internet by a high bandwidth optical fiber or wireless backhaul connection. As in other cell networks, a mobile device crossing from one cell to another is automatically transferred to the new cell. It should be understood that 5G networks are just an example type of communication network, and embodiments of the disclosure may utilize earlier generation wireless or wired communication, as well as later generation wired or wireless technologies that come after 5G. The game server 111 performs operations that enable video game players to play video games over the network 103. In a multiplayer gaming session, the game server 111 collects data from players at the client systems 101-1 to 101-N and distributes it to other players who are in data communication with the cloud game network 105. In some embodiments, the game server 111 implements services such as messaging, social utilities, audio communication, game play replay functions, help functions, among other services. In some embodiments, the cloud game network 105 supports artificial intelligence (AI) based services including chatbot services (e.g., ChatGPT, etc.) that provide for various AI-based automated operations, such as conversational communications, composition of written material, composition of music, answering questions, simulating a chat room, playing games, among other automated operations.

In some embodiments, the video game is executed by the game title processing engine 109. In some embodiments, the game title processing engine 109 implements the game logic 107 which directs performance of game calculations, physics computations, geometry transformations, rendering processes, lighting, shading, audio processing, as well as additional in-game and/or game-related services. In some embodiments, the game title processing engine 109 is implemented in a distributed manner by including a plurality of processing entities (PEs) acting as nodes, where each PE executes a functional segment of the game title processing engine 109. In some embodiments, one or more of the PEs is virtualized by a hypervisor of the game server 111. Also, in some embodiments, the game server 111 is in data communication with different PEs that reside on different server units within one or more data center(s). By distributing the game title processing engine 109 across multiple PEs, the game title processing engine 109 is provided with elastic computing properties that are not bound by the capabilities of a physical server unit. Instead, the game title processing engine 109 is provisioned with whatever number of PEs are needed to meet the current computing demands of the video game.

In some embodiments, the client computing system 101-x, where x is any of 1 to N, is configured with a game title processing engine, e.g., an instance of game title processing engine 109, and game logic, e.g., an instance of game logic 107, that is locally stored for at least some local processing of the video game, and may be further utilized for receiving streaming content as generated by the video game executing at the game server 111, or for receiving other content provided by back-end server support within the cloud game network 105. In some embodiments, the client computing system 101-x is configured as a thin client computing system configured to interface with a back-end server, such as with the game server 111 of the cloud game network 105. In these embodiments, the game server 111 provides computational functionality (e.g., access to game title processing engine 109 executing game logic 107) for executing the video game through the interface of the client computing system 101-x. In some embodiments, the client computing system 101-x of a player is configured to request access over the network 103 to a video game offered through the cloud game network 105, and render display images generated by the video game executing within the cloud gaming network 105, where encoded images are delivered (streamed) to the client computing system 101-x for rendering as the display images on the client computing system 101-x.

In some embodiments, the player interacts through the client computing system 101-x with an instance of a video game executing on the game title processing engine 109 of the game server 111 using input commands to drive play of the video game. In various embodiments, the client computing system 101-x receives input from various types of input devices, such as game controllers, tablet computers, keyboards, gestures captured by video cameras, mice, touch pads, audio input, HMD, etc. In some embodiments, the client computing system 101-x serves as a connection point for a controller device. The controller device communicates via a wireless connection or wired connection with the client computing system 101-x to transmit inputs from the controller device to the client computing system 101-1. The client computing system 101-x processes the inputs from the controller device and transmits corresponding input data to the game server 111 over the network 103. In some embodiments, the input data includes video and/or audio captured at the client computing system 101-x. Also, in some embodiments, the input data includes input from button(s), trigger(s), joystick(s), and/or motion detection hardware of the controller device. In some embodiments, the controller device is a networked device configured to communicate inputs directly through the network 103 to the game server 111, without having to communicate the inputs through the client computing system 101-x. In these embodiments, input from the controller device that does not depend on hardware or processing of the client computing system 101-x can be transmitted directly from the controller device to the game server 111. In some embodiments, inputs from the controller device that do not depend on hardware or processing of the client computing system 101-x include button inputs, joystick inputs, embedded motion detection inputs (e.g., accelerometer, magnetometer, gyroscope), among other inputs.

It should be appreciated that a given video game may be developed for a specific platform and associated controller device. However, when such a video game is made available through the cloud game network 105, the player may be accessing the video game with a different controller device, such as when the player accesses a video game designed for a gaming console from a personal computer utilizing a keyboard and mouse. In this situation, the cloud game network implements an input parameter configuration that defines a mapping from inputs which can be generated by the player's controller device to inputs which are acceptable for the execution of the video game by the game server 111. In another example, a player accesses the cloud game network 105 through a tablet computing device, a touchscreen smartphone, or other touchscreen driven device, where the client computing system 101-x and the controller device are integrated together, with inputs being provided by way of detected touchscreen inputs/gestures. For such a device, the input parameter configuration implemented by the cloud game network 105 may define particular touchscreen inputs corresponding to inputs for the video game that will be understood by the game server 111, such as button inputs, directional pad inputs, gesture or swipe inputs, touch motion inputs, among other inputs.

In some embodiments, the cloud game network 105 and game server 111 support a multi-player gaming session for a group of players, that includes delivering and receiving game data of multiple players. In some embodiments, the game server 111 coordinates and/or aligns objects and actions of multiple players within a scene of a video game, e.g., virtual space, virtual environment and/or metaverse, among others, and manages communications between players, so that players in distributed locations that are participating in a multi-player gaming session can interact with each other in real-time within the scene of the video game. In this manner, in some embodiments, the cloud game network 105 and game server 111 support multiple players simultaneously participating in and interacting with each other within a shared virtual space, virtual environment, and/or metaverse.

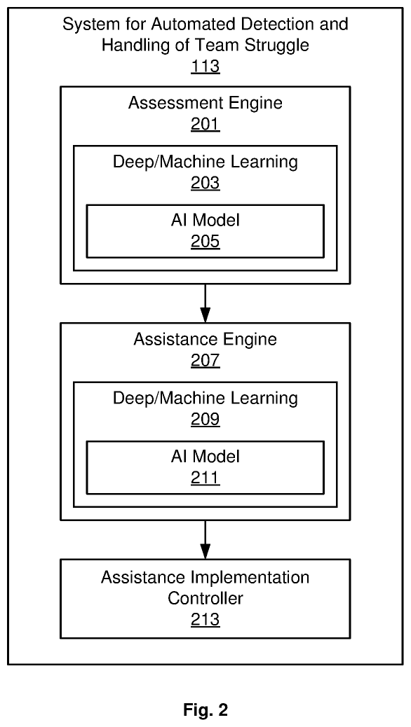

FIG. 2 shows an example configuration of the system for automated detection and handling of team struggle 113 in video game play, in accordance with some embodiments. The system includes an assessment engine 201, an assistance engine 207, and an assistance implementation controller 213. The assessment engine 201 includes a deep/machine learning architecture 203 that is configured to implement a first AI model 205 to evaluate a performance assessment parameter for a team of players engaged in play of a video game. The assistance engine 207 includes a deep/machine learning architecture 209 that is configured to implement a second

AI model 211 to determine an assistive measure for improving play of the team of players within the video game. In some embodiments, the assistance engine 207 is engaged when the assessment engine 201 determines that the evaluated performance assessment parameter is indicative of the team of players struggling in their play of the video game in a manner that is beyond what is considered normal and/or acceptable within the context/scenario of the video game. The assistance implementation controller 213 is configured to implement the assistive measure as determined by the assistance engine 207 within the video game.

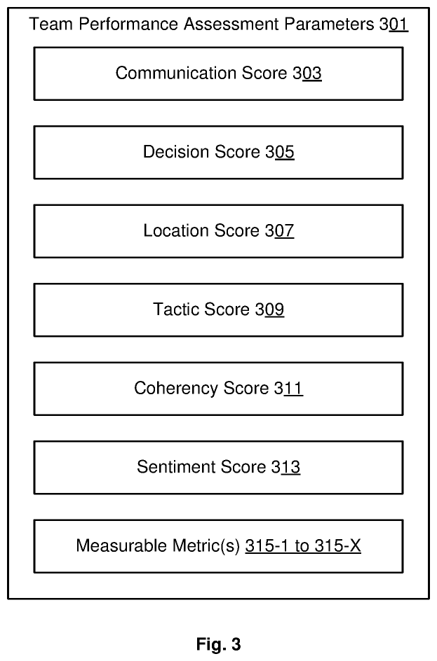

FIG. 3 shows a set of performance assessment parameters 301 for a team of players within a video game, in accordance with some embodiments. The set of performance assessment parameters 301 is evaluated by the assessment engine 201 using the deep/machine learning architecture 203 and first AI model 205. It should be understood that the set of performance assessment parameters 301 is provided by way of example. In various embodiments, the assessment engine 201 is configured to evaluate either a subset of the set of performance assessment parameters 301 and/or additional performance assessment parameters beyond those that are explicitly described with regard to FIG. 3.

In some embodiments, the set of performance assessment parameters 301 includes a communication score 303 defined to gauge communication between players within the team of players for which the set of performance assessment parameters 301 is evaluated. In some embodiments, the communication score 303 indicates a degree of similarity between player-to-player communications within the team of players and player-to-player communications within a set of training data reflective of successful team play within the video game that is used to train a corresponding aspect of the first AI model 205.

In some embodiments, the set of performance assessment parameters 301 includes a decision score 305 defined to gauge decisions made by players within the team of players for which the set of performance assessment parameters 301 is evaluated. In some embodiments, the decision score 305 indicates a degree of similarity between video game play decisions made by one or more players within the team of players and video game play decisions within a set of training data reflective of successful team play within the video game that is used to train a corresponding aspect of the first AI model 205.

In some embodiments, the set of performance assessment parameters 301 includes a location score 307 defined to gauge locations of players within the team of players for which the set of performance assessment parameters 301 is evaluated. In some embodiments, the location score 307 indicates a degree of similarity between locations of players within the team of players and locations of players within a set of training data reflective of successful team play within the video game that is used to train a corresponding aspect of the first AI model 205.

In some embodiments, the set of performance assessment parameters 301 includes a tactic score 309 defined to gauge tactics of players within the team of players for which the set of performance assessment parameters 301 is evaluated. In some embodiments, the tactic score 309 indicates a degree of similarity between tactics used by one or more players within the team of players and tactics of players within a set of training data reflective of successful team play within the video game that is used to train a corresponding aspect of the first AI model 205.

In some embodiments, the set of performance assessment parameters 301 includes a coherency score 311 defined to gauge a coherency of players within the team of players for which the set of performance assessment parameters 301 is evaluated. In some embodiments, the coherency score 311 indicates a degree of similarity between shared strategy and/or style among players within the team of players and shared strategy and/or style among players within a set of training data reflective of successful team play within the video game that is used to train a corresponding aspect of the first AI model 205.

In some embodiments, the set of performance assessment parameters 301 includes a sentiment score 313 defined to gauge a sentiment of players within the team of players for which the set of performance assessment parameters 301 is evaluated. In some embodiments, the sentiment score 313 indicates a degree of similarity between sentiments of players within the team of players and sentiments of players within a set of training data reflective of successful team play within the video game that is used to train a corresponding aspect of the first AI model 205.

In some embodiments, the set of performance assessment parameters 301 includes one or more measurable metric(s) 315-1 to 315-Z, where Z is any integer number greater than zero, within the video game. In some embodiments, one or more of the measurable metric(s) 315-1 to 315-Z includes a status of a condition that can be objectively determined as being present or not present within a state of the video game at a particular time. In some embodiments, one or more of the measurable metric(s) 315-1 to 315-Z includes a status of the team of players achieving a specified objective within the video game. It should be understood that the specified objective in the video game can be essentially any measurable property, state, or condition that occurs during play of the video game. In some embodiments, one or more of the measurable metric(s) 315-1 to 315-Z includes a status of the team of players achieving a specified objective within the video game within a set time period. In some embodiments, one or more of the measurable metric(s) 315-1 to 315-Z includes a status of the team of players achieving a specified objective within the video game in conjunction with team of players having a particular status/level within the video game. In some embodiments, one or more of the measurable metric(s) 315-1 to 315-Z includes a status of the team of players achieving a specified objective within the video game within a set time period in conjunction with the team of players having a particular status/level within the video game. It should be understood that the above-mentioned measurable metric(s) 315-1 to 315-Z are provided by way of example. In various embodiments, the measurable metric(s) 315-1 to 315-Z can include either a subset of the above-mentioned measurable metric(s) 315-1 to 315-Z or additional measurable metric(s) 315-1 to 315-Z beyond those that are explicitly described herein.

When the assessment engine 201 determines that a particular evaluated performance assessment parameter for the team of players of the video game is outside of one or more of an acceptable range, value, limit, status, etc., the assistance engine 207 is engaged to assist in remedying whatever may be adversely impacting the performance of the team of players within the video game. The assistance engine 207, using deep/machine learning architecture 209 and the second AI model 211, determines one or more assistive measures that can be implemented within the video game and/or performed by one or more of the players on the team of players to improve the play of the team of players within the video game. In some embodiments, the assistive measure is automatically implemented without notification and/or approval by the team of players. In some embodiments, the assistive measure is conveyed to one or more players within the team of players for approval prior to implementation of the assistive measure within the video game. In some embodiments, the assistive measure affects one or more particular players within the team of players. In some embodiments, the assistive measure affects an entirety of the team of players. In some embodiments, the assistive measure is conveyed/offered to one or more particular player(s) within the team of players. In some embodiments, the assistive measure is conveyed/offered to all players within the team of players.

In some embodiments, the assistive measure includes removal of one or more existing player(s) from the team of players. In some embodiments, the assistive measure includes addition of one or more new player(s) to the team of players. In some embodiments, the assistive measure includes both removal of one or more existing player(s) from the team of players and addition of one or more new player(s) to the team of players.

In some embodiments, the assistive measure includes provision of information to one or more players within the team of players on how to progress within the video game. For example, in some embodiments, the assistive measure conveys a strategy for play of the video game or provides an instruction on how to advance in play of the video game. In some embodiments, the assistive measure is conveyed just to one or more players within the team who are responsible for implementing the strategy for play of the video game or for following the instructions on how to advance in play of the video game. In some embodiments, the assistive measure is conveyed globally to the team of players, such that the team of players is collectively responsible for determining if and/or how to implement the assistive measure.

In some embodiments, the assistive measure includes adjustment of one or more tasks assigned to one or more player(s) within the team of players. In some embodiments, the assistive measure includes adjustment of an aspect of the video game. For example, in some embodiments, the assistive measure includes a change in the video game context/scenario that provides for easier advancement of the team of players within the video game.

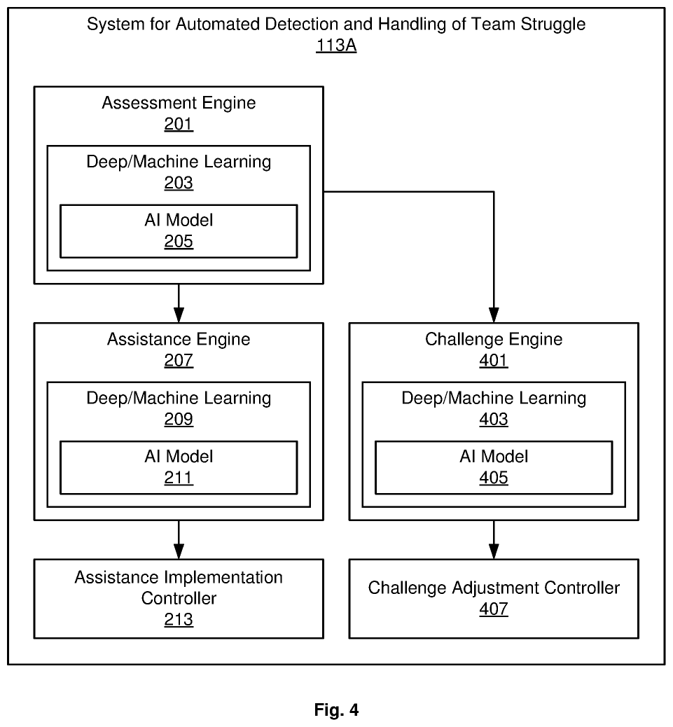

FIG. 4 shows an example configuration of a system for automated detection and handling of team struggle 113A in video game play, in accordance with some embodiments. The system 113A of FIG. 4 includes the system for automated detection and handling of team struggle 113 in video game play, as described with regard to FIG. 2. The system 113A of FIG. 4 further includes a challenge engine 401 that includes a deep/machine learning architecture 403 configured to implement a third AI model 405 to determine whether or not the team of players is being sufficiently challenged within the video game. The system 113A also includes a challenge adjustment controller 407 configured to automatically increase a difficulty level of the video game in response to the challenge engine 401 determining that the team of players is insufficiently challenged within the video game. For example, in some embodiments, if a team of players is advancing through a video game a rate that exceeds a preset upper threshold rate, the challenge adjustment controller 407 directs the video game to present a higher level of difficulty to the team players as they continue play of the video game. Conversely, in some embodiments, the challenge adjustment controller 407 is configured to automatically decrease the difficulty level of the video game in response to the challenge engine 401 determining that the team of players is excessively challenged within the video game. For example, in some embodiments, if a team of players is advancing through a video game a rate that is less than a preset lower threshold rate, the challenge adjustment controller 407 directs the video game to present a lower level of difficulty to the team players as they continue play of the video game.

The system for automated detection and handling of team struggle 113/113A operates to enhance an overall video game play experience for players of the video game, promote player engagement in the video game, and assist players in effectively overcoming challenges that they encounter in play of the video game, among other outcomes. The system 113/113A provides a struggle evaluator that is continuously watching the play of a team of players within a video game. Depending on the activity of the players (e.g., not being able to advance over a level, not being able to move as needed, not being able to accomplish a goal, not being able to effectively work as a team of players, among essentially any other activity), the system 113/113A determines if the team of players is struggling or not struggling in their collective play of the video game relative to what is considered normal and/or acceptable within the context/scenario of the video game. It should be understood that there are many ways in which a player can be struggling in their play of a video game, and these various ways of struggling depend on the context/scenario of the video game. Some examples of how one or more players or a team of players can be struggling in their play of a video game include issues such as being in the wrong place, performing the wrong task, taking the wrong approach, being unable to communicate effectively, having conflicts in play style, having conflicts in play strategy, among many other issues. In some embodiments, the assessment engine 201 of the system 113/113A is configured to recognize player frustration as a key indicator of the player struggling in play of the video game.

In some embodiments, the system 113/113A is configured to identify social forms of player struggle in the video game. For example, the system 113/113A is configured to identify the inability of one or more players to work with a team of players as a way in which the one or more players is/are socially struggling in their play of the video game. It should be understood that this social form of struggling is a nuanced level of struggling that may not be discernable through direct objective measurements, such as through some form of pass/fail criteria for a given task/goal within the video game. Rather, it should be understood that this social form of struggling is a nuanced level of struggling that is discernable through implementation of the deep/machine learning architecture 203 and the first AI model 205 of the assessment engine 201. In particular, the first AI model 205 is trained on data that conveys player actions and associated game states within play of the video game that manifest social forms of player struggle in play of the video game. Based on this training data, the first AI model 205 is able to detect whenever current player actions and associated game states indicate that one or more players or even a team of players is experiencing some form of struggle in their play of the video game due to some social friction and/or social incapacity.

In some embodiments, the first AI model 205 determines that a flawed approach exists at a team level to accomplish a required task in the video game. For example, such a flawed approach exists when a team of players has not divided responsibilities appropriately to accomplish a required task in the video game. In this particular example, the system 113/113A determines the flaw in the team's approach and recommends a corrective action to one or more players or to the team of players as a whole. For example, in some embodiments, the system 113/113A is configured to dynamically change and redistribute tasks among the players on a team of players to assist the team in its progression within the video game. In some embodiments, the corrective action determined by the assistance engine 207 of the system 113/113A is based on knowledge of the players' strengths and weaknesses in playing the video game and in working together with the team of players.

If the system 113/113A determines that the team of players is struggling in their collective play of the video game, the system 113/113A operates to assist the team of players in resolving whatever issue may be causing their struggle. For example, if the system 113/113A determines that player struggle exists because one or more players cannot work effectively with their team of players, the system 113/113A operates by either helping the team of players work better together or by redefining the team of players so as to resolve the issue that is causing the team of players to struggle. In some embodiments, the assistance engine 207 implements the deep/machine learning architecture 209 and the second AI model 211 to generate advice for the team of players on how to work together more effectively to progress in their play of the video game and avoid problematic struggle.

For example, in various embodiments, the system 113/113A operates to lower a difficulty level within the video game, assist one or more players in accomplishing a particular task or mechanic within the video game, assist players in their communication with each other, and/or provide assistance in essentially any other manner that will assist the team of players in advancing their play within the video game. In some embodiments, the system 113/113A operates to dynamically adjust game mechanics within the video game so as to reduce player difficulty. In some embodiments, the system 113/113A notifies other players of the video game that one or more players (or the team of players) has been assisted, also referred to as “boosted,” in their play of the video game, so that all players are aware of how the system 113/113A has given an advantage to one or more players within the video game. In some embodiments, when one or more players (or the team of players) appears to be frustrated in their play of the video game, the system 113/113A operates to provide a booster to one or more of the frustrated players. In some embodiments, the booster provides the one or more players with some form of automatic assistance or support in their play of the video game or with an enhanced ability to complete a task or an event more easily within the video game. For example, in some embodiments, instead of requiring a player to provide a complex input pattern to achieve a particular outcome, the system 113/113A provides a booster to simplify the required input pattern. Also, in some embodiments, the system 113/113A provide a booster for a player in which some required inputs for successful play of the video game are automatically performed on behalf of the player. In some embodiments, the booster provided by the system 113/113A appears within the video game as a game helper and/or a dynamic character/non-player character (NPC) that provides dynamic assistance to one or more players or a team of players when they are detected by the system 113/113A as struggling beyond what is considered normal and/or acceptable within the context/scenario of the video game.

In some embodiments, one or more players (or the team of players) is provided with an ability to notify other players within the video game that they were boosted. This allows for all players within the video game to be aware of who is receiving assistance by the system 113/113A in the interest of fairness and transparency. This notification mechanism prevents potential imbalances in play of the video game by informing all players about the presence of assistance or dynamic difficulty adjustments made by the system 113/113A. In some embodiments, when a booster is provided to a player by the system 113/113A, a notification of booster use is visually indicated on the video display of the video game, such as through display of a message like “I was boosted” in conjunction with a particular aspect of the video game to which the booster was applied. This visual display notification of booster use informs the other players that the boosted player (or team of players) is receiving assistance.

In some embodiments, the score and/or progress achieved within the video game by one or more players (or by the team of players) is highlighted/denoted as having been achieved with the assist/boost provided by the system 113/113A. In some embodiments, the score and/or progress achieved within the video game by one or more players (or by the team of players) is weighted downward to reflect the impact on the score that was provided by the assist/boost from the system 113/113A. In some embodiments, this score weighting is done to effectively maintain an equal and fair playing level for all players within the video game. In some embodiments, boosting of players or a team of players by the system 113/113A is limited to training sessions that occur outside of actual play of the video game with other players, so as to maintain a fair and competitive environment within the multiplayer video game.

Also, in some embodiments, the system 113/113A uses the challenge engine 401 to dynamically increase the difficulty level of game mechanics within the video game so as to promote player interest in playing of the video game. In some embodiments, the score and/or progress achieved within the video game by one or more players (or by the team of players) is highlighted/denoted as having been achieved by overcoming the increased difficulty in play of the video game as provided by the system 113/113A. In some embodiments, the score and/or progress achieved within the video game by one or more players (or by the team of players) is weighted upward to reflect the increased difficulty in play of the video game as provided by the system 113/113A. Again, in some embodiments, this score weighting is done to effectively maintain an equal and fair playing level for all players within the video game.

In various embodiments, the AI models 205 and 211 of the system 113/113A are trained based on the performance of a well-performing team of players, and are correspondingly used to identify teams of players that are not performing well in some aspect of video game play as compared to the well-performing team of players, such as by being non-compliant in team organization, non-compliant in team chat, non-compliant in weapon/tool selection, non-compliant in their amount of help before an attack, among essentially any other aspect of video game play. In this manner, the system 113/113A can help a lesser performing team of players conform to play more like the well-performing team of players. In some embodiments, the system 113/113A is implemented to operate based on objective metrics (goals). For example, the system 113/113A can be implemented to help a team of players achieve various goals within their play of the video game. The objective metrics are assessable by the system 113/113A to monitor/determine if the team is failing in their play of the video game. In various embodiments, the system 113/113A provides player-selectable options for selecting/setting the objective metrics that are assessed by the system 113/113A.

In some embodiments, the system 113/113A can be toggled on and off during play of the video game. In some embodiments, the system 113/113A is operated continuously in the background as the video game is played. In some embodiments, the system 113/113A is implemented within a particular video game. In some embodiments, the system 113/113A is implemented through an application programming interface (API) that is called by the video game as needed. In some embodiments, the system 113/113A is implemented at a platform level. In some embodiments, the system 113/113A is implemented under emulation for legacy video games. In some embodiments, the system 113/113A is implemented on a platform-wide basis, such as under emulation, with screen scraping and audio hashing for legacy video games.

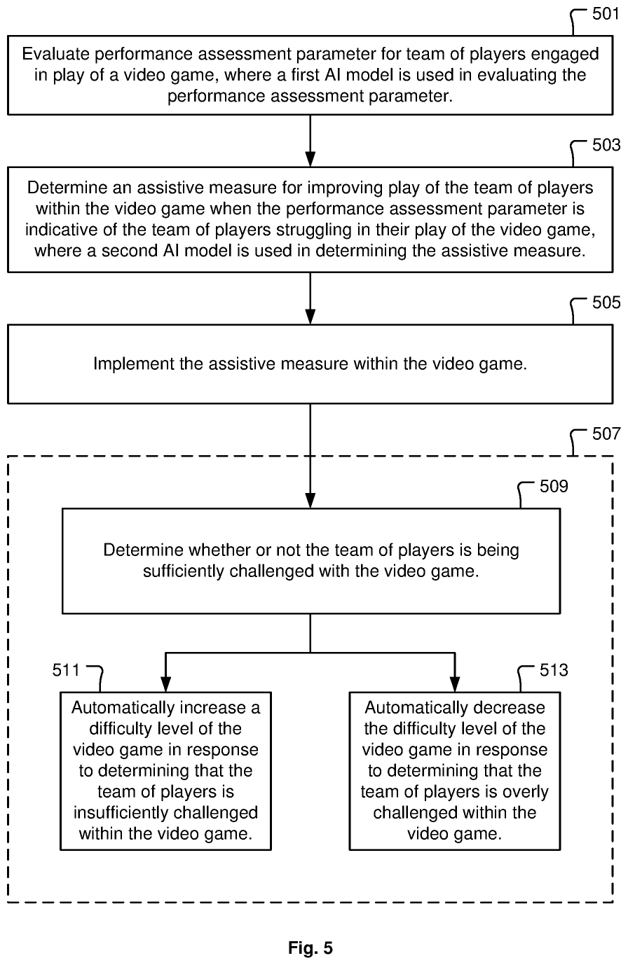

FIG. 5 shows a flowchart of a method for automatically detecting and handling team struggle in video game play, in accordance with some embodiments. The method includes an operation 501 for evaluating a performance assessment parameter for a team of players engaged in play of a video game, where the first AI model 205 is used in evaluating the performance assessment parameter. The method also includes an operation 503 for determining an assistive measure for improving play of the team of players within the video game when the performance assessment parameter, as evaluated in the operation 501, is indicative of the team of players struggling in their play of the video game, where the second AI model 211 is used in determining the assistive measure. The method also includes an operation 505 for implementing the assistive measure within the video game.

In some embodiments, the performance assessment parameter evaluated in operation 501 gauges communication between players within the team of players. For example, in some embodiments, the performance assessment parameter evaluated in operation 501 is the communication score for the team of players, as discussed above. In some embodiments, the performance assessment parameter evaluated in operation 501 gauges decisions made by players within the team of players. For example, in some embodiments, the performance assessment parameter evaluated in operation 501 is the decision score for the team of players, as discussed above. In some embodiments, the performance assessment parameter evaluated in operation 501 gauges locations of players within the team of players. For example, in some embodiments, the performance assessment parameter evaluated in operation 501 is the location score for the team of players, as discussed above. In some embodiments, the performance assessment parameter evaluated in operation 501 gauges tactics of players within the team of players. For example, in some embodiments, the performance assessment parameter evaluated in operation 501 is the tactic score for the team of players, as discussed above. In some embodiments, the performance assessment parameter evaluated in operation 501 gauges a coherency of players within the team of players. For example, in some embodiments, the performance assessment parameter evaluated in operation 501 is the coherency score for the team of players, as discussed above. In some embodiments, the performance assessment parameter evaluated in operation 501 gauges a sentiment of players within the team of players. For example, in some embodiments, the performance assessment parameter evaluated in operation 501 is the sentiment score for the team of players, as discussed above. In some embodiments, the performance assessment parameter evaluated in operation 501 is a measurable metric within the video game including one or more of achieving a specified objective within the video game, achieving the specified objective within the video game within a set time period, achieving the specified objective within the video game in conjunction with having a particular status within the video game, and achieving the specified objective within the video game within the set time period in conjunction with having the particular status within the video game, among other measurable metrics.

In some embodiments, the assistive measure determined in operation 503 includes one or more of removal of an existing player from the team of players and addition of a new player to the team of players. In some embodiments, the assistive measure determined in operation 503 includes provision of information to the team of players on how to progress within the video game. In some embodiments, the assistive measure determined in operation 503 includes adjustment of tasks assigned to the players within the team of players. In some embodiments, the assistive measure determined in operation 503 includes adjustment of an aspect of the video game.

In some embodiments, the method of FIG. 5 includes an optional challenge optimization process 507. The challenge optimization process 507 includes an operation 509 for determining whether or not the team of players is being sufficiently challenged with the video game. The challenge optimization process 507 also includes an operation 511 for automatically increasing a difficulty level of the video game in response to determining that the team of players is insufficiently challenged within the video game. The challenge optimization process 507 also includes an operation 513 for automatically decreasing the difficulty level of the video game in response to determining that the team of players is overly challenged within the video game. In some embodiments, the third AI model 405 is used in determining whether or not the team of players is being sufficiently challenged with the video game.

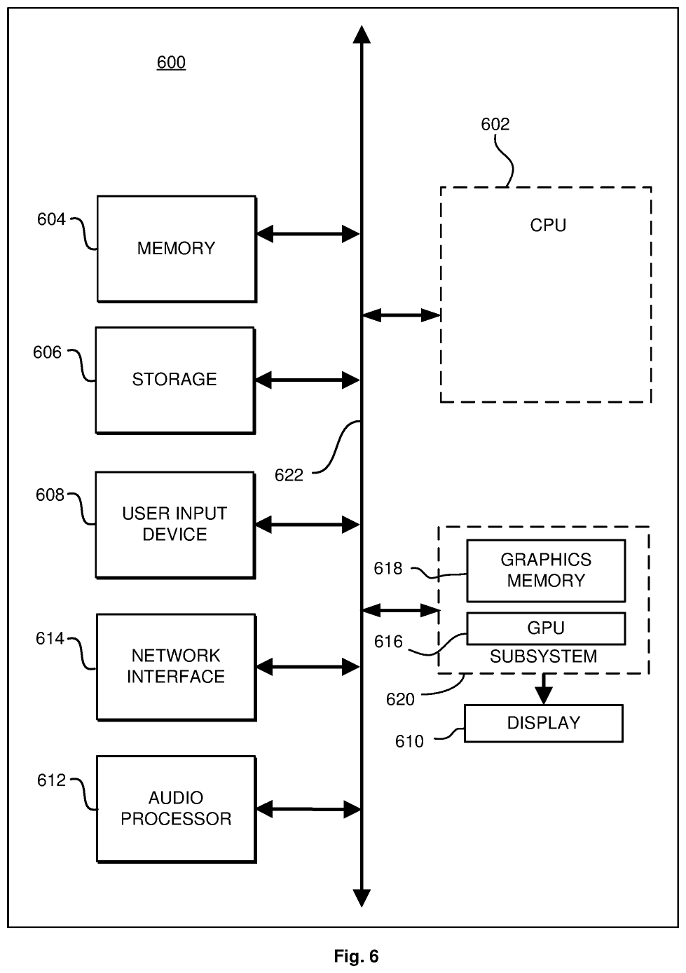

FIG. 6 shows various components of an example server device 600 within a cloud-based computing system that can be used to perform aspects of the system 113/113A and method for automatically detecting and handling team struggle in video game play, in accordance with some embodiments. This block diagram illustrates the server device 600 that can incorporate or can be a personal computer, video game console, personal digital assistant, a head mounted display (HMD), a wearable computing device, a laptop or desktop computing device, a server or any other digital computing device, suitable for practicing an embodiment of the disclosure. The server device (or simply referred to as “server” or “device”) 600 includes a central processing unit (CPU) 602 for running software applications and optionally an operating system. The CPU 602 may be comprised of one or more homogeneous or heterogeneous processing cores. For example, the CPU 602 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 600 may be localized to a player playing a game segment (e.g., game console), or remote from the player (e.g., back-end server processor), or one of many servers using virtualization in the cloud-based gaming system 600 for remote streaming of game play to client devices.

Memory 604 stores applications and data for use by the CPU 602. Storage 606 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 608 communicate user inputs from one or more users to device 600, examples of which may include keyboards, mice, joysticks, touch pads, touch screens, still or video recorders/cameras, tracking devices for recognizing gestures, and/or microphones. Network interface 614 allows device 600 to communicate with other computer systems via an electronic communications network, and may include wired or wireless communication over local area networks and wide area networks such as the internet. An audio processor 612 is adapted to generate analog or digital audio output from instructions and/or data provided by the CPU 602, memory 604, and/or storage 606. The components of device 600, including CPU 602, memory 604, data storage 606, user input devices 608, network interface 614, and audio processor 612 are connected via one or more data buses 622.

A graphics subsystem 620 is further connected with data bus 622 and the components of the device 600. The graphics subsystem 620 includes a graphics processing unit (GPU) 616 and graphics memory 618. Graphics memory 618 includes a display memory (e.g., a frame buffer) used for storing pixel data for each pixel of an output image. Graphics memory 618 can be integrated in the same device as GPU 616, connected as a separate device with GPU 616, and/or implemented within memory 604. Pixel data can be provided to graphics memory 618 directly from the CPU 602. Alternatively, CPU 602 provides the GPU 616 with data and/or instructions defining the desired output images, from which the GPU 616 generates the pixel data of one or more output images. The data and/or instructions defining the desired output images can be stored in memory 604 and/or graphics memory 618. In an embodiment, the GPU 616 includes 3D rendering capabilities for generating pixel data for output images from instructions and data defining the geometry, lighting, shading, texturing, motion, and/or camera parameters for a scene. The GPU 616 can further include one or more programmable execution units capable of executing shader programs.

The graphics subsystem 620 periodically outputs pixel data for an image from graphics memory 618 to be displayed on display device 610. Display device 610 can be any device capable of displaying visual information in response to a signal from the device 600, including CRT, LCD, plasma, and OLED displays. In addition to display device 610, the pixel data can be projected onto a projection surface. Device 600 can provide the display device 610 with an analog or digital signal, for example.

Implementations of the present disclosure for the system 113/113A and associated methods for automatically detecting and handling team struggle in video game play may be practiced using various computer device configurations including hand-held devices, microprocessor systems, microprocessor-based or programmable consumer electronics, minicomputers, mainframe computers, head-mounted display, wearable computing devices and the like. Embodiments of the present disclosure can also be practiced in distributed computing environments where tasks are performed by remote processing devices that are linked through a wire-based or wireless network.

With the above embodiments in mind, it should be understood that the disclosure can employ various computer-implemented operations involving data stored in computer systems. These operations are those requiring physical manipulation of physical quantities. Any of the operations described herein that form part of the disclosure are useful machine operations. The disclosure also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

Although various method operations were described in a particular order, it should be understood that other housekeeping operations may be performed in between the method operations. Also, method operations may be adjusted so that they occur at slightly different times or in parallel with each other. Also, method operations may be distributed in a system which allows the occurrence of the processing operations at various intervals associated with the processing.

One or more embodiments can also be fabricated as computer readable code (program instructions) on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices, or any other type of device that is capable of storing digital data. The computer readable medium can include computer readable tangible medium distributed over a network-coupled computer system so that the computer readable code is stored and executed in a distributed fashion.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

What is claimed is:

1. A system for automated detection and handling of team struggle in video game play, comprising:
an assessment engine configured to implement a first artificial intelligence (AI) model to evaluate a performance assessment parameter for a team of players engaged in play of a video game;
an assistance engine configured to implement a second AI model to determine an assistive measure for improving play of the team of players within the video game, the assistance engine engaged when the assessment engine determines that the performance assessment parameter is indicative of the team of players struggling in their play of the video game; and
an assistance implementation controller configured to implement the assistive measure as determined by the assistance engine within the video game.

2. The system as recited in claim 1, wherein the performance assessment parameter gauges communication between players within the team of players.

3. The system as recited in claim 2, wherein the performance assessment parameter includes a communication score for the team of players, the communication score indicating a degree of similarity between player-to-player communications within the team of players and player-to-player communications within a set of training data reflective of successful team play within the video game.

4. The system as recited in claim 1, wherein the performance assessment parameter gauges decisions made by players within the team of players.

5. The system as recited in claim 4, wherein the performance assessment parameter includes a decision score for the team of players, the decision score indicating a degree of similarity between video game play decisions made by one or more players within the team of players and video game play decisions within a set of training data reflective of successful team play within the video game.

6. The system as recited in claim 1, wherein the performance assessment parameter gauges locations of players within the team of players.

7. The system as recited in claim 6, wherein the performance assessment parameter includes a location score for the team of players, the location score indicating a degree of similarity between locations of players within the team of players and locations of players within a set of training data reflective of successful team play within the video game.

8. The system as recited in claim 1, wherein the performance assessment parameter gauges tactics of players within the team of players.

9. The system as recited in claim 8, wherein the performance assessment parameter includes a tactic score for the team of players, the tactic score indicating a degree of similarity between tactics used by one or more players within the team of players and tactics of players within a set of training data reflective of successful team play within the video game.

10. The system as recited in claim 1, wherein the performance assessment parameter gauges a coherency of players within the team of players.

11. The system as recited in claim 10, wherein the performance assessment parameter includes a coherency score for the team of players, the coherency score indicating a degree of similarity between shared strategy and style among players within the team of players and shared strategy and style among players within a set of training data reflective of successful team play within the video game.

12. The system as recited in claim 1, wherein the performance assessment parameter gauges a sentiment of players within the team of players.

13. The system as recited in claim 12, wherein the performance assessment parameter includes a sentiment score for the team of players, the sentiment score indicating a degree of similarity between sentiments of players within the team of players and sentiments of players within a set of training data reflective of successful team play within the video game.

14. The system as recited in claim 1, wherein the performance assessment parameter is a measurable metric within the video game including one or more of achieving a specified objective within the video game, achieving the specified objective within the video game within a set time period, achieving the specified objective within the video game in conjunction with having a particular status within the video game, and achieving the specified objective within the video game within the set time period in conjunction with having the particular status within the video game.

15. The system as recited in claim 1, wherein the assistive measure includes one or more of removal of an existing player from the team of players and addition of a new player to the team of players.

16. The system as recited in claim 1, wherein the assistive measure includes provision of information to the team of players on how to progress within the video game.

17. The system as recited in claim 1, wherein the assistive measure includes adjustment of tasks assigned to the players within the team of players.

18. The system as recited in claim 1, wherein the assistive measure includes adjustment of an aspect of the video game.

19. The system as recited in claim 1, further comprising:
a challenge engine configured to implement a third AI model to determine whether or not the team of players is being sufficiently challenged with the video game; and
a challenge adjustment controller configured to automatically increase a difficulty level of the video game in response to the challenge engine determining that the team of players is insufficiently challenged within the video game.

20. The system as recited in claim 19, wherein the challenge adjustment controller is configured to automatically decrease the difficulty level of the video game in response to the challenge engine determining that the team of players is excessively challenged within the video game.
